(19) United States
(12) Patent Application Publication
(10) Pub. No.: US 2017/0004285 A1
(43) Pub. Date: Jan. 5, 2017

(54) EXERCISE TRAINING SYSTEM AND METHOD

(71) Applicant: Paul ANDERTON, Fairview Park (AU)

(72) Inventor: Paul ANDERTON, Fairview Park (AU)

(21) Appl. No.: 15/125,788

(22) PCT Filed: Mar. 13, 2015
(86) PCT No.: PCT/AU2015/000141

§ 371 Date: Sep. 13, 2016

(30) Foreign Application Priority Data
Mar. 13, 2014 (AU) 2014900866

(51) Int. Cl. G06F 19/00

(52) U.S. Cl. CPC G06F 19/3481; G06F 19/324

(57) ABSTRACT

An exercise monitoring system (10) is disclosed. An embodiment of the exercise monitoring system (10) includes a motion sensing unit (12) and a processing SENSE MOTION DURING THE EXERCISE ACTIVITY AND unit (14). The motion sensing unit (12) senses motion during an exercise activity including plural repetitions, and provides sensor data based on the sensed motion. The processing unit (14) processes the sensor data to determine values of each of one or more exercise parameters associated with a muscle or muscle group stressed by the exercise activity for each repetition, detect each of the plural repetitions of the exercise activity and associate each determined value of the one or more exercise parameters with a respective detected repetition. The values of the one or more exercise parameters include a value of timing and/or duration information for at least one of an eccentric, eccentric pause, concentric, or concentric pause phase of a muscle or muscle group stressed by the exercise activity.

This international application claims priority from Australian Provisional Patent Application No 2014900866 filed on 13 Mar. 2014 the entire contents of which are herein incorporated by this reference.

### FIELD OF THE INVENTION

The present invention relates to a device, system and method monitoring execution of an exercise activity. In a typical application, embodiments of the present invention may find application in a resistance training programme for the purpose of monitoring specific training parameters or performance analysis thereof.

### BACKGROUND OF THE INVENTION

Resistance training is the practice of placing a subject's skeletal muscles under load, typically via eccentric and concentric contractions of a prescribed movement for a number of 10 consecutive repetitions (“sets”) which may be repeated several times (“reps”) with a rest between each set. In some forms of resistance training, the aim is to elicit an increase in muscle size or strength or both.

Generally speaking, conventional training methods employ variations of the set/repetition (rep) schemes and/or variations of contraction profiles (exercise execution) to generate a response in a muscle or muscles worked by the exercise, with some methods being more effective than others. For example, set/repetitions schemes may be varied to create responses which are biased towards particular outcomes, such as heavy weights with, for example, four (4) repetitions or less for predominantly strength gains and, for example, eight (8) to twelve (12) repetitions for size gains (hypertrophy) of a muscle group worked by the exercise.

Furthermore, within these training schemes there are other variables which may be varied for the performance of the ‘exercises’ including but not limited to:
the speed of the repetition, both in the concentric phase and the eccentric phase and the ‘pause’ between both—with all factors collectively known as the ‘tempo’ of the repetition;
the load profile: which may be considered as the “effective” load on the working muscles at each stage of the exercise as the muscles contract and the forces vary due to the changing angle of incidence of gravity in relation to the skeletal structure, the changing factors of leverage of the joint(s) and tendon(s) involved, or the load profile of a camshaft if an exercise machine incorporating a cable and/or camshaft is used, or simply the technique of the exercise performance such that the trainee deliberately alters their stance, position, or limbs during the exercise to elicit a particular load effect;
various ‘overload’ techniques designed to increase the overall stress on the muscle—including but not limited to: forced reps, rest-pause, pre-exhaust exercises, drop sets, compound sets, giant sets, and “x” reps.

There are thus a plurality of parameters which may be analysed to determine or at least classify the training effect and/or effectiveness of an exercise activity.

Existing approaches for monitoring the execution of an exercise activity typically involve a trainer or a trainee (that is, the person executing the exercise activity) manually monitoring and recording a limited set of parameters such as a weight, and number of repetitions and the number of sets, as may be prescribed, for example, in a training programme. Unfortunately, approaches of this type are of limited value in terms of determining the effect or effectiveness of the exercise activity since they provide an overly simplistic record of the exercise activity, and overlook how the exercise activity was executed. Furthermore, even in circumstances where a trainer may record additional execution related parameters, the accuracy of these parameters may be questionable.

It would be desirable to provide a method and system which provides an improved approach for determining the effect or effectiveness of an exercise activity, such as a resistance training based exercise activity.

### SUMMARY OF THE INVENTION

A first aspect of the present invention provides an exercise monitoring system, including:
a motion sensing unit for sensing motion during an exercise activity including plural repetitions, and providing sensor data based on the sensed motion; and
a processing unit for processing the sensor data to:
   determine a value for each of one or more exercise parameters associated with a muscle or muscle group stressed by the exercise activity for each repetition;
   detect each of the plural repetitions of the exercise activity; and
   associate each determined value of the one or more exercise parameters with a respective detected repetition;
wherein the values of the one or more exercise parameters include a value of timing and/or duration information for at least one of an eccentric, eccentric pause, concentric, or concentric pause phase of a muscle or muscle group stressed by the exercise activity.

Throughout this specification, references to the term “eccentric phase” are to be understood to denote a reference to a contraction of a muscle which lengthens the muscle while producing a force during the exercise activity. Examples of eccentric contraction include lowering a dumbbell, or performing a calf press off of a ledge. References to the term “eccentric pause phase” are to be understood to denote a momentary static or rest position when the muscle is maintained in an eccentric phase.

References to the term “concentric phase” are to be understood to denote a reference to a contraction of a muscle which shortens the muscle as it acts against a force during the exercise activity. Examples of eccentric contraction include the lifting phase of a bicep curl. References to the term “concentric pause phase” are to be understood to denote a momentary static or rest position where the muscle is maintained in a concentric phase.

It is envisaged that processing the sensor data may enable determination of other values of timing and/or duration information for additional parameters of the exercise activity, including one or more of:
the start of an exercise activity;
the start of each set of an exercise activity;
the end of each set of an exercise activity;
the rests or recovery period between each set of an exercise activity; and
the end of the exercise activity (which may be determined as the last rep of the last set.

The exercise activity executed by a subject may include a resistance training exercise. Examples of resistance training exercise activities include strength training exercises such as isotonic and/or isometric exercises. An exercise activity may involve exercise equipment such as resistance bands, free weights, or exercise machines, or it may be performed using the subject's body weight. Examples of isotonic exercises include squats, bench press, lat pull downs, dumbbell flyes, cable flyes, bar bell curls, calf raises, chin ups, sit ups, push-ups, and the like.

The resistance training exercise may involve displacing a load over a range of motion, and the sensed motion may include the motion of the load the attributable to the stressing of the muscle or muscle group during the exercise activity. The exercise activity may involve one or more weights (wt), one or more of sets (s) including one or more repetitions (R), performed in a given tempo and a total activity (elapsed) time (Te) for the exercise.

It is envisaged that some exercise activities may require plural motion sensing units for location, for example, on different areas of the user's body (or indeed one or more exercise equipment items) involved in the execution of an exercise activity involving, for example, multiple limbs, and potentially different muscle groups. Hence, some embodiments of the invention may involve multiple motion sensing units.

In an embodiment, the motion sensing unit may include at least one accelerometer and the sensor data may be indicative of acceleration and/or a displacement during execution of the exercise activity.

It is envisaged that the motion sensing unit may also include other embedded sensors, such as environmental sensors (such as a temperature sensor), or personal monitoring sensors (such as a heart rate sensor) for providing additional sensor data which may be used to analyse the exercise activity in combination with the values of timing and/or duration information for at least one of an eccentric, eccentric pause, concentric, or concentric pause phase of a muscle or muscle group stressed by the exercise activity. Suitable environmental sensors and personal monitoring sensors would be well understood by a person skilled in the art.

The motion sensing unit may be configured to be attached and/or affixed to training equipment (such as, a barbell or a moving part of the exercise equipment), or alternatively it may be configured to worn by the subject executing the activity on a part of the body that will provide an accurate representation of an exercise movement for each repetition of the exercise activity (for example, the wrist for barbell bench press).

The motion sensing unit preferably includes a first accelerometer for providing sensor data based on sensed motion directed along a first axis and a second accelerometer for providing sensor data based on sensed motion directed along a sensing motion directed along a second axis. Preferably, the first accelerometer and the second accelerometers are arranged so that the first and second axes are orthogonal axes. In some embodiments, the motion sensing unit includes a third accelerometer for providing third sensor data based on sensed motion directed along a third axis. Preferably, the third accelerometer is arranged so that the first, second and third axes are orthogonal axes.

In embodiments of the present invention in which the motion sensing unit includes at least one accelerometer, the processing unit may process the sensor data from each of the at least one accelerometers to thereby determine the value of the timing and/or duration information at least one exercise parameter associated with a muscle or muscle group stressed by the exercise activity and identify each of the plural repetitions of the exercise activity. Advantageously, embodiments of the present invention may determine movement parameters to discern the values of the timing and/or duration information for at least one of an eccentric, eccentric pause, concentric, or concentric pause phase of the muscle or muscle group stressed by the exercise activity irrespective of the orientation and/or alignment of the motion sensing means based on a type or category of the exercise activity so that at least one sensing axis of the motion sensing unit is aligned with a plane of motion of the exercise activity.

The processing unit may be integrated with the motion sensing unit, or it may be a separate unit in wireless communication with the motion sensing unit. For example, in some embodiments, the motion sensing unit may be worn by the user, or attached or otherwise affixed to an item of exercise equipment, whereas the processing unit may be located remotely from the motion sensing unit and in communication therewith via a suitable communications interface.

In embodiments in which the motion sensing means and the processing unit are not integrated, the processing unit may include hardware and software items operating on a computing device in communication with the motion sensing means either directly, or indirectly via a network. For example, the processing unit may include a mobile device such as a mobile phone, a tablet, a laptop computer or the like equipped with suitable program instructions in the form of program code which is executable by the processing unit. Alternatively, the processing unit may include a desktop computer. Providing a separate processing unit may provide a trainer or coach with the capability to monitor the one or more exercise parameters executed by a user (that is, a “trainee”) in real time, and thus to provide feedback to the user on the execution based on that monitoring.

In some embodiments the motion sensing unit may include a wireless network interface for communicating indirectly with the processing unit via a communication network. Alternatively, the motion sensing unit may include a wireless transmitter for communicating the sensor data to a wireless receiver of the processing directly means via a wireless communications interface. Suitable wireless interfaces may include a short range radio data interface (such as a Bluetooth or ZigBee data interface), a packet data interface such as an IEEE 802.11 (“WiFi” interface), a wireless USB interface, or another suitable wireless interface protocol. Other suitable wireless interface types would be well known to a skilled reader.

The sensor data may include analogue information, in the form of a signal, or digital information in the form of a digital code.

The motion sensing unit may include an attachment means for affixing or attaching at least the motion sensing unit to the user, or exercise apparatus or exercise equipment item displaced during the exercise activity. The type and arrangement of the attachment means may thus vary according to the application of the motion sensing unit. Suitable attachment means may include a magnetic attachment means, a band (such as a “slap-band”), a strap or the like. A band, such as a memory metal “slap band”, or a Velcro band, may allow attachment of the motion sensing unit in situations where attaching the motion sensing unit to, for example, a weight stack is impractical, and also be suitable for particular exercise activities, such as dips or chin-ups, where it may be required to affix the accelerometer to, for example, the user's belt, to track the motion. Preferably, the band is configured to accommodate a variety of affixing or attaching requirements without having to adjust the band length or associated fixing devices.

In embodiments which include an attachment means, the attachment means may be secured to the motion sensing unit via a damping medium to thereby at least partially attenuate shock when, for example, a weight is returned to a remainder of a stack. Alternatively, the motion sensing unit may be configured to have an operating range which sustains the typical values of deceleration encountered in use.

The motion sensing unit may include a means for selecting and/or indicating the “start” and/or “stop” of the exercise activity where the “start” is the time of the first repetition of the first set and the “stop” is the time of the final repetition of the last set, which may of course include the first set. The means for selecting and/or indicating the “start” and/or “stop” of the exercise activity may be provided with the motion sensing means, or alternatively it may be provided on the processing unit in communication with the motion sensing means, such as a tablet, mobile wireless device, desktop computer, laptop computer, or a remote control unit in either directly or indirectly in communication with the motion sensing means. For example, the means for selecting the “start” and/or “stop” of the exercise activity may include a user interface device or control operatively associated with a processing unit connected to the internet, or running a local “native” application on the processing unit for direct processing of the waveform.

Suitable means for indicating the “start” and/or “stop” of the exercise activity may include an audio signal generator, a tactile feedback means (such as a vibrating means), and/or a visual indicator.

An embodiment of the present invention may further include an input means, such as a user control, for entering one or more attributes associated with the exercise activity. Example attributes include attributes identifying and/or classifying a type or a category of the exercise activity.

In some embodiments, an indicating means may be provided for indicating to the user or trainer a required orientation and/or alignment of the motion sensing means based on the type or category of the exercise activity so that at least one sensing axis is aligned with a plane of motion of the exercise activity. An input means may also be provided for entering, for example, a weight associated with the exercise activity.

Processing the sensor data by the processing unit may include processing the sensor data to detect each one of plural repetitions of the exercise activity. Furthermore, the processing means may assign a value to each detected repetition according to the position of the repetition in a sequence of a plurality of detected repetitions. Furthermore, some embodiments of the present invention may include algorithmic and signal processing means for determining and differentiating different sets, being consecutive repetitions of the exercise activity, and furthermore determine movement parameters for each detected repetition to discern the value of a duration for at least one of an eccentric, eccentric pause, concentric, or concentric pause phase of the muscle or muscle group stressed by the exercise activity according to claim sensing means based on the type or category of the exercise activity so that at least one sensing axis is aligned with a plane of motion of the exercise activity

In an embodiment, a computer readable memory is provided for storing prescribed attributes for one or more exercise activities, the prescribed attributes including at least a number of prescribed repetitions for each of the one or more exercise activities. In such embodiments, it is possible that processing the sensor data by the processing unit includes comparing each assigned repetition value with a number of prescribed repetitions of the at least one exercise activity to identify the end of the exercise activity. It will be appreciated that it is not essential that detected repetitions are compared with a value of a number of prescribed repetitions of the at least one exercise activity to identify the end of an exercise activity since in some embodiments the motion sensing unit and processing unit are able to detect the repetitions and record them based on characteristics of the motion of the motion sensing unit, In this respect. processing the sensor data to determine the repetitions may include Neural Networks (such as artificial intelligence systems) which involves “training” the system to recognise various signal configurations that represent typical signals for various exercise activities, and it subsequently storing various “decoding biases” that enable the system to recognise future repetitions that conform to the required pattern (and hence score a high probability via the weights or biases),

The prescribed attributes stored for one or more exercise activities may also include one or more additional attributes for each of the one or more exercise activities, such as, the number of sets and prescribed values for the one or more exercise parameters for each repetition and/or set, that is, prescribed values of timing and/or duration information for the at least one of an eccentric, eccentric pause, concentric, or concentric pause phase of a muscle or muscle group stressed by the exercise activity. In other words, the prescribed attributes may define the intended timing and/or duration information for executing the exercise activity, as opposed to the determined values which indicate actual execution information. These attributes may be accessed during execution of the exercise activity for comparison with the determined plural values of one or more exercise parameters associated with a muscle or muscle group stressed by the exercise activity for each repetition and/or a detected repetition of the exercise activity against the stored prescribed respective attributes. A comparison of this type may, for example, allow embodiments of the present invention to automatically track progress and/or variation of an exercise activity, and communicate information to the user and/or trainer in relation to that progress.

For example, some embodiments of the present invention may be able to determine the number of completed repetitions of the exercise activity and the number of repetitions of the exercise activity remaining for a particular set, and similarly, the number of completed sets of the exercise activity and the number of sets of the exercise activity remaining. The prescribed attributes may be stored in the form of a reference table including values for the at least one of an eccentric, eccentric pause, concentric, or concentric pause phase of the muscle or muscle group stressed by the exercise activity such that no user and/or operator intervention is required for the system to detect the start and end or progression from one set to the next and one exercise to the next.

Furthermore, during execution of the exercise activity, comparing the prescribed values for the one or more exercise parameters for each repetition against the determined respective values for the one or more exercise parameters may allow embodiments of the present invention to detect variations between the actual and desired execution of the exercise activity and alert the user to that variation. For example, if the prescribed value of an eccentric phase for a repetition of an exercise activity is two seconds, and the determined value of an eccentric phase for the respective repetition is one second, it is possible that the system may generate an alert signal, such as an audible, visible or tactile signal indicating to the user that the eccentric phase was too short.

Associating each determined value of the one or more exercise parameters with a respective detected repetition may include entering the one or more exercise parameters for each respective detected repetition in a relational database so as to store an association therebetween, together with other attributes of the exercise activity. Once so stored, the one or more exercise parameters for each respective detected repetition, and attributes of the exercise activity, may be indexed and analysed to determine attributes indicating the effectiveness of effect of the exercise activity. One method for determining attributes indicating the effectiveness of the effect of the exercise activity is disclosed in International Patent Application No PCT/AU2013/000571, the entire contents of which are herein incorporated by reference.

Another aspect of the present invention provides an exercise monitoring system, exercise monitoring system, including:
a motion sensing unit for sensing motion during an exercise activity including plural repetitions, and providing sensor data based on the sensed motion, the motion sensing unit includes at least one accelerometer such that the sensor data is indicative of acceleration and/or displacement during execution of the exercise activity;
a computer readable memory storing prescribed attributes for the exercise activity, the prescribed attributes including at least the number of prescribed repetitions of the exercise activity;
a processing unit for processing the sensor data to:
   determine a value for each of one or more exercise parameters associated with a muscle or muscle group stressed by the exercise activity, the plural values including a value of timing and/or duration information for at least one of an eccentric, eccentric pause, concentric, or concentric pause phase of a muscle or muscle group stressed by the exercise activity;
   detect each of the plural repetitions of the exercise activity; and
   associate each determined value of at the least one exercise parameters with a respective detected repetition; and
memory means for storing the association between each of the plural values of the one or more exercise parameters and a respective detected repetition.

In an embodiment, the prescribed attributes included prescribed timing and/or duration values for the one or more monitored exercise parameters.

The computer readable memory may also store a set of rules in the form of a computer executable algorithm. This algorithm may, for example, enable differentiation of the “start” and “stop” of each repetition or set (that is, a fixed number of repetitions) by detecting a periodic pattern in the sensor data possibly within limits or a constraint denoted by markers for the “start” and “stop” of a set. In this case, “start” indicates that the set is about to start and the processing algorithm may then detect the first repetition automatically based on a characteristic of the sensor data, through to the last repetition, whilst substantially continuously recording time information for what it detects as the last repetition and logging that once it is confirmed by the “stop” marker that the set has ceased.

Alternatively, the computer executable algorithm may enable differentiation of the “start” and “stop” of each set by detecting the rhythmic movement of the waveform within markers for the “start” and “stop” of the exercise—i.e. “start” will mean that the exercise (of “x” sets) is about to start and the processing algorithm identifies the repetitions of each set automatically based on a characteristic of the sensor data, through to the last set, whilst substantially continuously recording time information for each of the repetitions and logging that information and a time stamp of the last repetition of the last set as the “end” time of the exercise once it is confirmed by the “stop” market that the exercise has ceased.

Yet another aspect of the present invention provides a method for monitoring an exercise activity including plural repetitions, the method including:
providing a motion sensing unit to sense motion during the exercise activity and provide sensor data based on the sensed motion; and
processing the sensor data to:
   determine a value for each of one or more exercise parameters associated with a muscle or muscle group stressed by the exercise activity;
   detect each of the plural repetitions of the exercise activity; and
   associate each determined value of the at least one exercise parameters with a respective detected repetition;
wherein the plural values of the one or more exercise parameters includes a value of timing and/or duration information for at least one of an eccentric, eccentric pause, concentric, or concentric pause phase of a muscle or muscle group stressed by the exercise activity.

A method embodiment of the present invention will thus preferably process the sensor data of the motion sensing unit to derive timing and/or duration information of the various phases of each repetition from each cycle corresponding to each repetition of an exercise activity.

Yet another aspect of the present invention provides a method for monitoring an exercise activity including plural repetitions, the method including:
providing a motion sensing unit for sensing motion during an exercise activity including plural repetitions, and providing sensor data based on the sensed motion, the motion sensing unit includes at least one accelerometer such that the sensor data is indicative of acceleration and/or displacement during execution of the exercise activity;
providing a computer readable memory storing prescribed attributes for the exercise activity, the prescribed attributes including at least a number of prescribed repetitions of the exercise activity for execution as a set;
processing the sensor data to:
   determine a value for each of one or more exercise parameters associated with a muscle or muscle group stressed by the exercise activity, the determined values including a value of timing and/or duration information for at least one of an eccentric, eccentric pause, concentric, or concentric pause phase of a muscle or muscle group stressed by the exercise activity;
   detect each of the plural repetitions of the exercise activity; and
   associate each determined value of the one or more exercise parameters with a respective detected repetition;
   compare the detected number of repetitions with the prescribed number of repetitions; and
   identify the end of the set according to the comparison.

### BRIEF DESCRIPTION OF THE DRAWINGS

The present invention will now be described in relation to various examples illustrated in the accompanying drawings. However, it must be appreciated that the following description is not to limit the generality of the above description.

In the drawings:

FIG. 1 is a block diagram of a system according to an embodiment of the present invention;

FIGS. 2A and 2 B show example exercise activities using a motion sensing unit according to an embodiment;

FIG. 3 shows an example sensed signal for an example exercise activity using a motion sensing unit according to an embodiment;

FIG. 4 is a block diagram of a motion sensing unit according to an embodiment;

FIG. 5 is a block diagram of a system according to another embodiment;

FIG. 6 is a block diagram of a motion sensing unit according to a second embodiment;

FIG. 7 is a flow diagram of a method embodiment;

FIG. 8A is a diagram of a sensed signal of a motion sensing unit according to an embodiment in use; and

FIG. 8B is a diagram of a sensed signal of a motion sensing unit according to an embodiment in use.

### DETAILED DESCRIPTION OF A PREFERRED EMBODIMENT

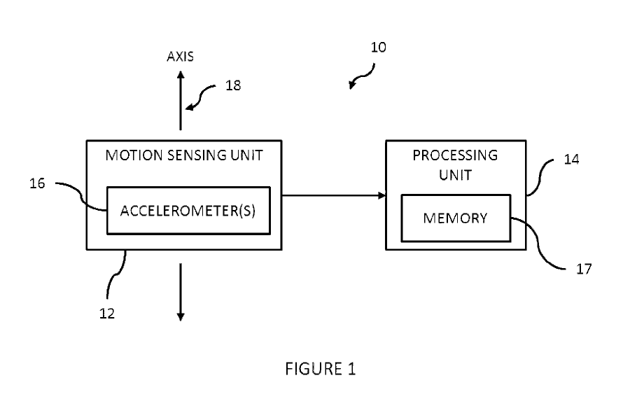

According to an embodiment of the present invention, there is provided an exercise monitoring system 10, as shown in FIG. 1. The system 10 includes a motion sensing unit 12 for sensing motion during an exercise activity including plural repetitions, and providing sensor data based on the sensed motion. As shown, the system 10 also includes a processing unit 14 for receiving the sensor data from the motion sensing unit 12 and processing that data to derive the values of timing and/or duration information for the one or more exercise parameters of the exercise activity.

In the illustrated embodiment, the processing of the sensor data determines values of one or more exercise parameters associated with a muscle or muscle group stressed by the exercise activity for each repetition, and identifies each of the plural repetitions of the exercise activity. Each determined value of the one or more exercise parameters is then associated with a respective detected repetition. The exercise monitoring system 10 may be implemented using hardware, software or a combination thereof and may be implemented in one or more computer systems or processing systems. In particular, the functionality of the processing unit 14 may be provided by one or more computer systems capable of carrying out the above desired functionality.

The one or more exercise parameters preferably include values of timing and/or duration information of one or more of at least one of an eccentric (Ec), eccentric pause (Ep), concentric

(Con), or concentric pause phase (Cp) of a muscle or muscle group stressed by the exercise activity.

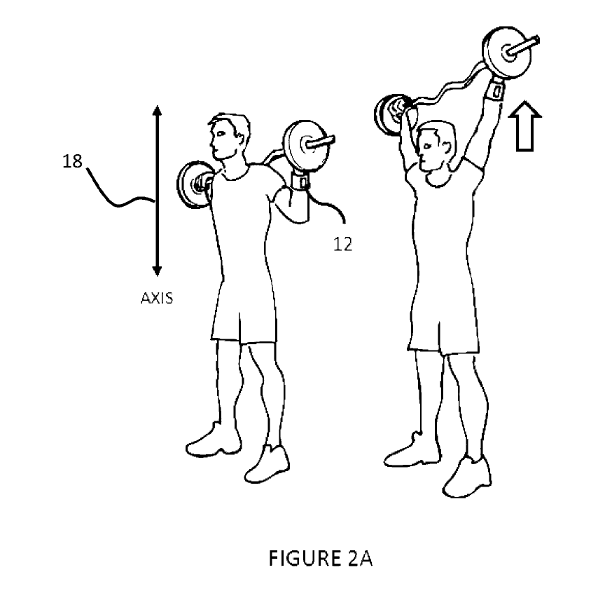

In embodiments, the motion sensing unit 12 is capable of transmitting sensor data which includes information regarding the acceleration and/or displacement of the motion sensing unit 12 during an exercise activity. In the embodiment illustrated, the motion sensing unit 12 includes at least one accelerometer 16 for providing an output signal including sensor data indicative of acceleration and/or displacement along an axis 18 (ref. FIG. 2A and FIG. 2B). However, it is envisaged that the system 10 may include a number of such accelerometers to sense acceleration and/or displacement along multiple axes, with each of the accelerometers associated with a respective one of the axes.

Turning now to FIG. 2A (showing a shoulder press exercise activity) and FIG. 2B (showing a lat pull down exercise activity), there is shown a motion sensing unit 12 including an attachment means for affixing or attaching at least the motion sensing unit 12 to the user (in other words, the trainee), as shown in FIG. 2A, or exercise apparatus or exercise equipment item displaced during the exercise activity, as is shown in FIG. 2B.

The type and arrangement of the attachment means may thus vary according to the application of the motion sensing unit. Suitable attachment means may include a magnetic attachment means, a band (such as a “slap-band”), a strap or the like. A band such as a memory metal “slap band”, or a Velcro band may allow attachment in situations where attaching to a weight stack is impractical, and also be suitable for particular exercise activities, such as dips or chin-ups, where it may be required to affix the accelerometer to, for example, the user's belt, to track the motion. Preferably, the band is configured to accommodate a variety of situations without having to adjust the band length or fixing devices.

In embodiments which include an attachment means, the attachment means is preferably secured to the motion sensing unit 12 via a damping medium to thereby at least partially attenuate shock when, for example, weights are returned to a remainder of the stack. Alternatively, the motion sensing unit 12 may be configured to have an operating range which sustains typical values of deceleration encountered in use.

In still other embodiments, the motion sensing unit 12 may be integrated with an item of exercise equipment, and provided with an identifier which may be unique or representative of a type or category of exercise activity performed on or in the exercise equipment. In such embodiments, the identifier may be communicated with the sensor data. The processing unit 14 may then store, or access, a database including relationships between the identifier (or the exercise type or category) and information which associates a direction of displacement with one or both of the eccentric (Ec) and/or concentric phases (Con) of a muscle or muscle group stressed by the exercise activity performed on the equipment. In other words, the processing unit 14 may store information which identifies a relationship between sensor data received from the motion sensing unit and its respective associated phase.

For example, the relationship between sensor data received from the motion sensing unit and its respective associated phase may be defined in a database containing information which associates a direction of displacement and the phases of the movements and the signal conventions from the motion sensing unit 12, as shown in Table 1:

TABLE 1

| | Primary | Gravity | | |
|---|---|---|---|---|
| Exercise Activity | axis | sense | Eccentric start | Concentric start |
| Bench press | Y | Y | −Y acceleration | +Y acceleration |
| Shoulder press | Y | Y | −Y acceleration | +Y acceleration |
| Barbell bent row | Y | −Y | +Y acceleration | −Y acceleration |
| Dumbbell bent row | Y | −Y | +Y acceleration | −Y acceleration |

Continuing now with reference to FIG. 2A and FIG. 2B, it will be appreciated that in FIG. 2A the eccentric phase commences with a downward movement of the motion sensing unit 12 whereas the concentric phase commences with an upward movement of the motion sensing unit 12. On the other hand, in the exercise activity shown in FIG. 2B, the eccentric phase commences with an upward movement whereas the concentric phase commences with a downward movement of the motion sensing unit 12.

An advantage of embodiments of the present invention is, that by storing or accessing relationships between direction of displacement and one or both of the eccentric (Ec) and/or concentric phases (Con) of a muscle or muscle group stressed by an exercise activity, embodiments of the present invention may be able to derive exercise phase information from the sensor data, and in particular, values of timing and/or duration information for at least one of an eccentric, eccentric pause, concentric, or concentric pause phase of a muscle or muscle group stressed by the exercise activity. These derived values of timing and/or duration information may then be stored in a database in a memory 17 located on board the processing unit, or remotely. It will be appreciated by those persons skilled in the art that the memory 17 may be hosted in the processing unit 14 or by one or more servers in data communication with the processing unit 14.

The values of timing and/or duration information may be stored with reference to, or in association with, an identifier of the respective repetition of the exercise activity in a respective field of the database in the memory 17 so that this information can be used for subsequent analysis. In some embodiments, the values of timing and/or duration information may be populated into a database including respective prescribed values.

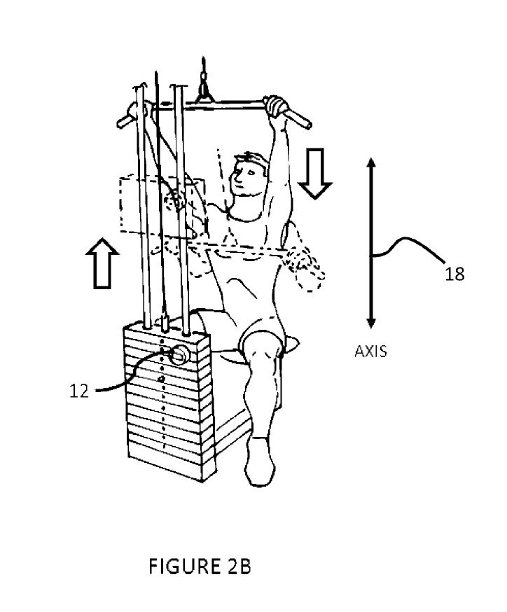

FIG. 3 shows an output signal 19 including sensor data from a motion sensing unit 12 according to an embodiment when used for an exercise activity of the type shown in FIG. 2B. For the illustrated signal 12, the derivation of the timing and/or duration information involves processing the sensor data to detect attributes of displacement, acceleration and/or velocity ity which are indicative of start points (for example, start points Cpₛ, Epₛ) or end points (for example, end points Cp_{f}, Ep_{f}) of the one or more exercise parameters of the exercise activity, and then determining values of the timing and/or duration information. For example, for each repetition the duration of each phase of each repetition may be determined as follows (subscript “f”=finish and “s”=start):
Eccentric phase duration: Ec=Ec_{f}−Ecₛ (that is, time of the eccentric finish—time of eccentric start)
Eccentric pause phase duration: Ep=Ep_{f}−Epₛ
Concentric phase duration: Con=Con_{f}−Conₛ
Concentric pause phase duration: Cp=Cp_{f}−Cpₛ

In the example illustrated in FIG. 3, the timing of the end of the eccentric phase is determined as the start of the eccentric pause phase, and thus Ec_{f}=Epₛ. Similarly, the timing of the beginning of the eccentric phase is determined as the end of the concentric pause phase, hence Ecₛ=Cp_{f}. Accordingly, in this example the duration of the eccentric phase may be expressed as:

Ec=Epₛ−Cp_{f}

Similarly, the duration of the concentric phase may be expressed as:

Con=Cpₛ−Ep_{f}

Further, for each set of plural repetitions n, average durations may be determined as follows:

Cp=(Cp1+Cp2+ . . . Cpn)/n

Ec=(Ec1+Ec2+ . . . Ecn)/n

Ep=(Ep1+Ep2+ . . . Epn)/n

Con=(Con1+Con2+ . . . Conn)/n

Where “n” is the number of repetitions in the set, including repetitions 1 to n.

Embodiments of the present invention may be able to discern different sets, and thus different exercise activities of an exercise program including plural exercise activities, and populate an exercise database accordingly. In this way, embodiments of the present invention may determine, for example, that a first exercise activity has finished and a second exercise activity has commenced.

For example, an exercise database may include a list or program of “prescribed” workouts as in Table 2:

TABLE 2

| Activity | Sets | Reps | Weight (kg) |
|---|---|---|---|
| Bench press, flat, barbell. | 3 | 12 | 50 |
| Lat pulldowns, close grip. | 3 | 10 | 55 |

Embodiments of the system 10 may detect when the program has started based either on detection of a manual “start” activation, or following the system 10 detecting an initial motion of the motion sensing device 12 associated with the initial exercise activity having characteristics which are consistent with a first repetition of the exercise activity. The system 10 then monitors movements of the motion sensing unit 12 to determine that the first set has started and then detect subsequent repetitions. In this example, after detecting three such sets of twelve repetitions of a bench press exercise activity, the system 10 determines that the next activity will be lat pulldowns (unless the trainee over-rides the automated system and adds an extra set manually).

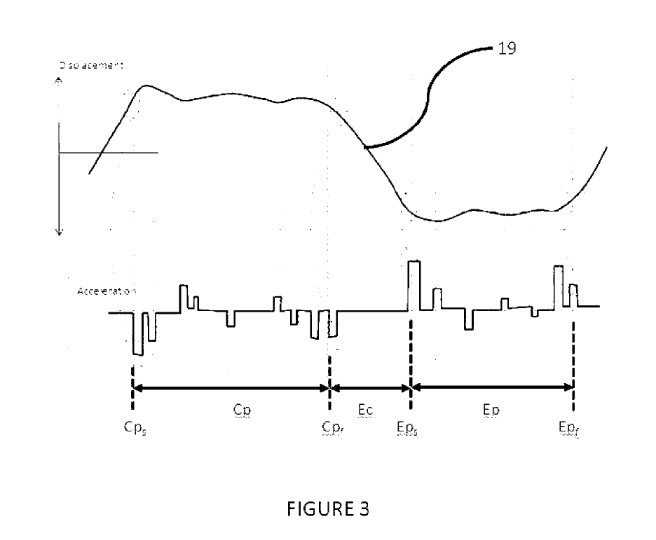

Turning now to FIG. 4, an embodiment of the motion sensing unit 12, includes a power supply 20, the at least one accelerometer 16, a controller 22, a communications interface 24, and user controls 26. The power supply 20 provides electrical power to components of the motion sensing unit 12 and may include a battery or an inductively charged power supply.

The at least one accelerometer 16 may include a tri-axial accelerometer configured to provide an output signal including sensor data indicative of acceleration and/or displacement along a respective axis of orthogonal axes. In other words, sensed data for each of an x, y and z axis. In use, the controller 22 samples a sensed signal from the at least one accelerometer 16 and provides, as an output to the communications interface 24, sensor data based on motion sensed by the at least one accelerometer for output communication by the communications interface 24. Any suitable controller may be used. One example of a suitable controller is the Texas Instruments® 8051 MCU. Other suitable controllers would be known to a person skilled in the art.

The sensed signal may be sampled by the controller 22 at a fixed sample frequency, or alternatively it may involve a sample rate which increases when the transitions (rate of change) of the sensed signal are greatest, such as near a static or turning point, to provide improved timing resolution at these points in the analysis. It is envisaged that a sampling interval of 100 ms will be sufficient. However, higher sampling rates can of course be used either at a fixed rate or one that varies according to the rate of transition of the signal, increasing the rate at the turning points for greater resolution as described earlier. Preferably, the controller 22 samples the sensed signal at a sampling rate of at least 100 mS, and preferably 50 mS.

The communications interface 24 receives the sensor data from the controller 22 and transmits a wireless signal including the sensor data to the processing unit 14. The communications interface 24 may include a conventional communications wireless interface such as Bluetooth®, Wi-Fi, Zig-Bee, Wireless USB, or ANT+compatible communications interface.

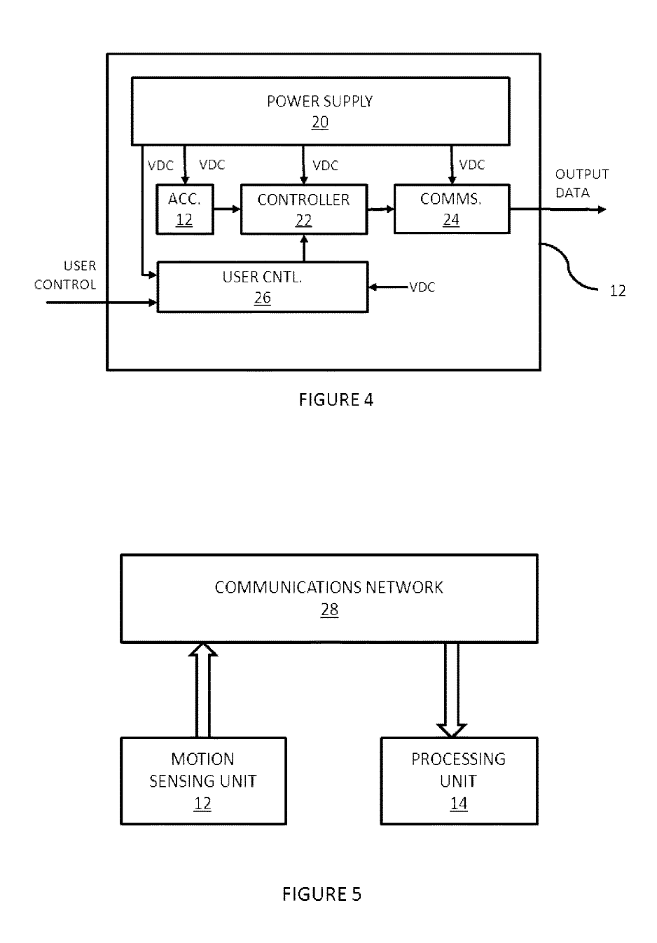

As a further alternative, and as shown in FIG. 5, communications interface 24 may output a wireless signal for communicating sensor data to the processing unit 14 via a network 28. For example, in some cases the communications interface 24 may include a cellular and/or computer network interface for communicating with a router, mobile base station, wireless access point (WAP) of a communications network 28. The wireless signal may then be formatted according to a communication standard supported by the communications network 28. The communications network may include a local area network (LAN), a wide area network (WAN), or a public mobile network (such as a WCDMA network, a 2G network, 3G network, or a 4G network).

Returning again to FIG. 4, user controls 26 may include controls for controlling the motion sensing unit 12, such as switches (not shown) for on/off control, communications interface 24 activation or the like. For example, in some embodiments, a user control 26 may be provided to enable or disable the communications interface 24 for transmission.

In the embodiment depicted in FIG. 4, the communicated output signal includes the sensed data indicative of acceleration and/or displacement along the axis 18 for processing by the processing unit 14. The processing unit 14 then derives the values of timing and/or duration information for the exercise parameters of the exercise activity. The processing unit 14 may include, for example, a mobile computing device provided with processing software. Suitable mobile computing devices include a mobile phone, tablet, laptop computer or the like. The functionality of the processing software will be described later.

In the embodiment illustrated in FIG. 4, the motion sensing unit 12 does not store information concerning the exercise activity type or the prescribed (target) repetitions. Instead, it communicates an output signal derived from the sensed data to the processing unit 14. The processing unit 14 includes suitable software for receiving the output data from the motion sensing unit 12 and processing that data.

Although in some embodiments, processing of the sensed data is performed by a processing unit 14 in wireless communication with the motion sensing unit 12, it is possible that the processing unit 14 may be provided with the motion sensing unit 12. In such embodiments, the sensed data need not be wirelessly transmitted for processing remotely, but may instead be performed by the processing unit 14 on-board the motion sensing unit 12 for storage and subsequently download. For example, FIG. 5 depicts a second embodiment of the motion sensing unit 12 in which the processing unit 14 is provided with the motion sensing unit 12.

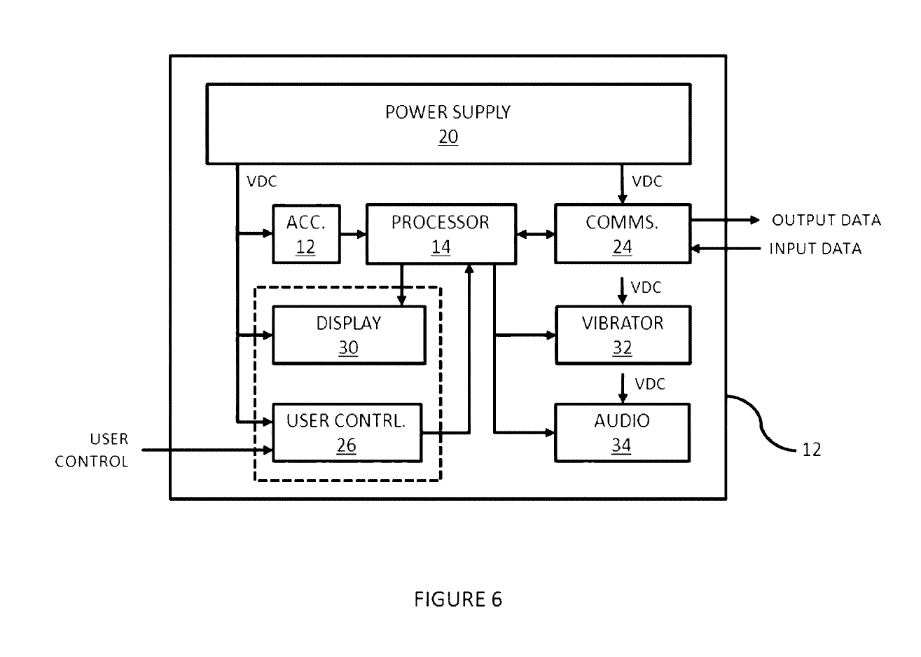

The embodiment illustrated in FIG. 6 further includes a display 30, a vibrator 32, and an audio output device 34, such as a speaker. Display 30 may provide a user with activity instructions, statistical information derived from the sensed data, timing information or the like. The activity instructions may include information on the type of activity to be executed, and associated attributes such as the weight, and required execution parameters, such as the number of repetitions, rest period, and phase timing information, such values of timing and/or duration information for at least one of an eccentric, eccentric pause, concentric, or concentric pause phase of a muscle or muscle group stressed by the exercise activity. These attributes may be entered into the memory 17 (ref. FIG. 1) of the processing unit 14 as input data using the user controls 26, which may include a touch type control of the display 30, prior to the user performing the activity either by the user, or via a device (not shown) in communication with the communications interface 24. Vibrator 32 and/or audio output device 34 may provide a user with tactile and/or audio feedback in use. For example, the vibrator 32 and audio output device 34 may generate a feedback indicating to the user information in relation to the status and/or execution of an exercise activity, such as the start of an exercise activity, the completion of an exercise activity, or the timing of the repetitions of an exercise activity.

It will of course be appreciated that is not essential that the embodiment illustrated in FIG. 4 includes a vibrator 32 and/or an audio output device 34. However, embodiments which include a vibrator 32 and/or an audio output device 34 may assist the user with executing an exercise activity correctly.

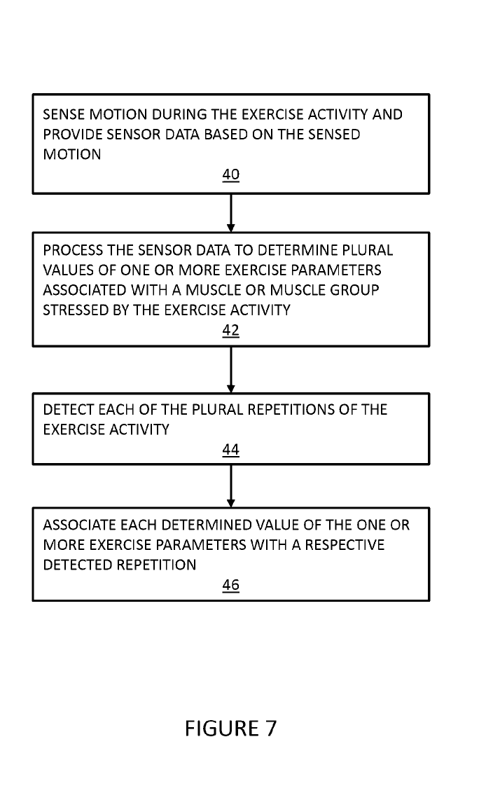

FIG. 7 is a flowchart illustrating an embodiment of a method for monitoring an exercise activity including plural repetitions. Initially, motion sensing unit 12 senses motion during the exercise activity and provides sensor data based on the sensed motion at step 40. At step 42 the processing unit 14 processes the sensor data to determine values of one or more exercise parameters associated with a muscle or muscle group stressed by the exercise activity and, at step 44, detect each of the plural repetitions of the exercise activity. Each determined value of the one or more exercise parameters is then associated, at step 46, with a respective detected repetition. The values of the one or more exercise parameters include a value of timing and/or duration information for at least one of an eccentric, eccentric pause, concentric, or concentric pause phase of a muscle or muscle group stressed by the exercise activity.

Different embodiments of the present invention may apply different techniques for processing and analysing the sensed data. However, each embodiment involves using the accelerometer to determine the repetitions of an exercise and the phases of the repetitions (tempo), and possibly other attributes.

Accordingly, embodiments of the present invention may determine:
a number of repetitions of an exercise activity in a set;
the duration of the set;
the phase timing of each repetition;
the starting direction of the first repetition which has a bearing on the number of repetitions (i.e. knowing how the repetitions started and hence how they finish) as well as the tempo conventions, i.e. knowing which time segments to allocate to each of the phases, eccentric, eccentric pause, concentric, and concentric pause.

In some embodiments, processing of the sensed data is retrospective. However, it is possible that the processing may be performed simultaneously with the execution of the exercise activity.

In an embodiment which utilises a 3-axis accelerometer, processing the sensor data to determine values of one or more exercise parameters associated with a muscle or muscle group stressed by the exercise activity and detect each of the plural repetitions of the exercise activity may involve:
1. Receiving the sensed data from the 3-axis accelerometer.
2. Filtering the sensed data to smooth each accelerometer signal. In some embodiments, a low pass filter (LPF) or moving average may be used to also reduce drift affecting the signal and cause valid peaks to drop below a detection threshold.
3. Determining a dominant sensed “signal” (and thus a dominant or primary axis of motion) as the sensed signal with the “cleanest” signal, or, if the signal-to-noise ratio SNR and the accelerometer signal is relatively small on two of the signals, combine all signals as a vector product.
4. Removing DC component and drift.
5. Identifying a segment of the sensed signal associated with the execution of exercise activity. This may involve, for example, a histogram approach, looking for the dominant frequency and the relative strength and occurrence. For example, a high incidence of peaks at set intervals (periods, and hence frequency) may indicate a repetitive or rhythmic signal. Alternatively, uncharacteristic sections of the signal can be removed via biases or gateways based upon the signal properties, as will be explained later.
6. Determining the start of the repetitive movement and record the time offset, being the time the wave form recording starts and the start of the first cycle of the repetitive wave. This time, or time offset may then be used to determine the duration of the overall exercise activity as one of the parameters of interest. This duration may be determined as follows:
   a. (End of last repetition time offset from recording start)−(offset of start of first repetition from recording start)=total set duration;
   b. Or, (sum of all phases of all repetitions)=total set duration;
   c. Using (b), the start offset time for the set duration is not required, but may be used to determine the total rest between each set. That is, total rest between set n and n+1=offset from the last repetition of the previous set to the end of the recording of the set+time between the end of the recording of the previous set and the start of the recording of the next set+the offset of the start of the first repetition of the set from the start of recording of the set;
   7. Remove start and end segments that are not characteristic of a repetition movement (for examples, segments which include static points, or which are indicative of erroneous motion).
   8. Remove any DC offset in the remaining signal. That is, distribute equally about the axis (peaks are equidistant and/or zero crossings are maximised). This may involve averaging the position of each peak, and comparing each peak with the previous peak to remove the offset or drift of each wave successively.

The acceleration signals are then related to displacement, as follows.
v=a.t (a=dυ/dt) hence (υ=∫ a.t)
s=v.t (υ=ds/dt) hence (s=∫ v.t)
and t is always a constant, fixed sample period

Hence, the sensed signal may be processed knowing that a change in rate of change of acceleration identifies a transition point where the motion sensing unit 12 is in one of three states:
starting to move from a stationary position;
slowing down to a “pause” phase where there is no movement; or
slowing down to start moving in the opposite direction at the end of a movement where there is no pause.

The characteristics of the sensor data may thus indicate the following attributes of an exercise activity:
an initial movement which represents the first repetition and the start of the exercise, and the actual movement indicating the time of the start of the exercise.
the movement in each phase will be ascertained as the eccentric or concentric part of the repetition, as determined by an exercise database that correlates the phases with the expected acceleration for the exercise activity in relation to gravity (i.e. for bench-press, acceleration in the direction of gravity is eccentric; with cable rows, acceleration of the weight stack opposite to gravity is concentric). For example, when the motion sensing unit is attached to a weight-stack, movement opposite to the direction of gravity is the concentric phase
cessation of the acceleration will indicate a pause at the end of the eccentric or concentric phase.
a subsequent movement will represent the eccentric or concentric phase of the movement, in opposition of the initial phase.
the subsequent cessation will represent the concentric or eccentric pause of the movement, being the opposite end of the repetition of the initial pause.

Note that in each case, the data includes the time of each phase, not just the value of the acceleration data.

By using signal processing techniques such as the vector dot product (RMS) mentioned above, or similar techniques of processing sensor data for each of the plural accelerometers independently to determine the movements, embodiments of the present invention may derive values of the one or more exercise parameters without requiring a specific orientation and/or alignment of the motion sensing unit in use. In other words, the signal processing is such that the axes do not need to be aligned with a plane of motion of the exercise activity,

As described earlier with reference to Table 1, the relationship between the above movements and attributes of the one or more exercise parameters will depend on relationship between the relative motion of the motion sensing unit and the phases of the exercise activity. For example, a bench press typically starts with eccentric contraction phase, whereas bicep curls start with a concentric contraction phase.

### EXAMPLE 1

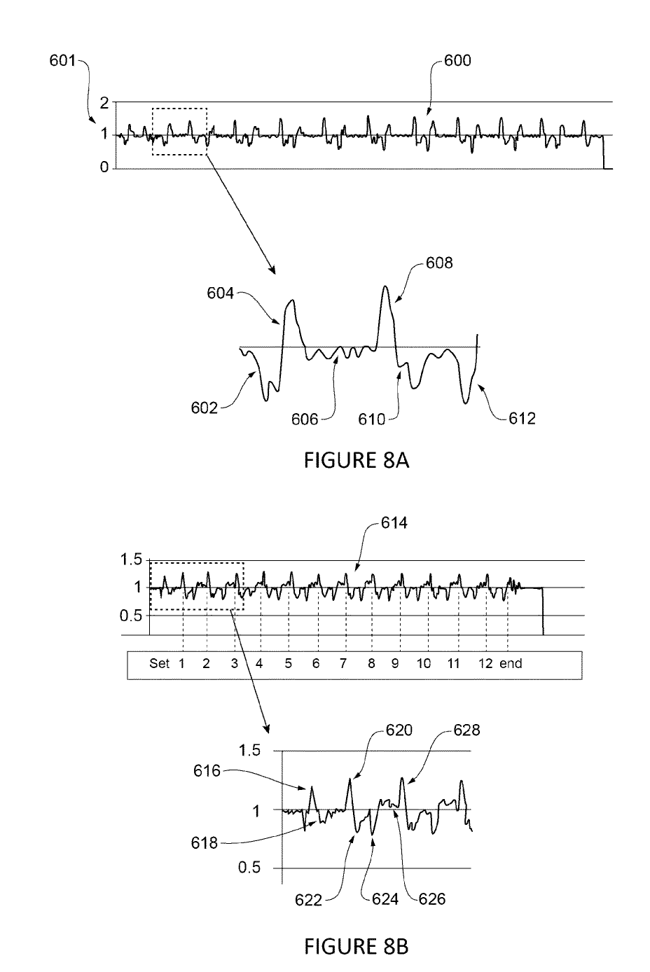

FIG. 8A illustrates a sensed signal 600 for an exercise activity having an approximate execution tempo of “1, 2, 1, 1” (and which initially moves the motion sensing unit 12 downwards). In the illustrated example, the exercise activity may include a lateral pull down with the motion sensing unit 12 attached to the trainee's wrist, or a bar attached to, or bearing, a weight.

In this example, the tempo “1, 2, 1, 1” is represented in the convention Ec, Ep, Con, Cp with Ec, in this case, being a downward movement. In other words, the exercise activity involves a 1 second eccentric contraction phase (Ec), a 2 second eccentric pause phase (Ep), a 1 sec concentric contraction phase (Con), and a 1 second concentric pause phase (Cp).

As shown in FIG. 8A, the sensed signal 600 is relative to a 1 g steady state position 601 (the axis 601 is clearly aligned with gravity, though this is not always the case and is not a requirement)—the acceleration relative to the steady state is negative. The insert figure shows the sensed signal 600 with a DC offset removed and centred about the zero axis. As shown, in this example, negative acceleration 602 indicates that the motion sensing unit 12 has started a downward movement of the exercise activity. Positive acceleration 604 is then required to stop the movement.

Acceleration then ceases as a steady state is maintained at 606, followed by positive acceleration 608 to initiate an upward movement associated with a second repetition. A momentary negative acceleration 610 then indicates a pause in the upward movement, before returning to zero acceleration while the upward position is maintained.

Negative acceleration 612 then indicates the downward movement of the second repetition.

In view of the above, it will be appreciated that in the above example:
1. A large positive acceleration indicates that the motion sensing unit 12 has started an initial movement, which in Example 1 is an upward transition;
2. A negative acceleration following an upward acceleration may indicate that that motion sensing unit has slowed down:
   a. either to a standstill of followed by acceleration at zero or tending to zero momentarily;
   b. or slowed and turned around the other way if the negative trend in acceleration tends to last a while and is not followed by a period of zero or near-zero acceleration and is subsequently followed by a positive trend in acceleration
3. If:
   a. the negative acceleration is followed by a period of zero or near-zero acceleration then a second negative period of acceleration may be expected as the motion sensing unit starts to return to its original position; and
   b. the motion sensing unit 12 “turns” around immediately then there will be no decrease and secondary negative increase. Instead, after a longer negative tendency, the motion sensing unit may output a positive acceleration as it slows
4. As per point 2, but in opposite conventions, the motion sensing unit will either slow to a complete standstill or will turn around immediately, which will give rise to respectively, a tendency to zero and then another positive acceleration, or a single positive acceleration.

It will be appreciated that other movements may involve similar logic but in opposite polarity may apply for other movements. Indeed, it will be appreciated that there are many combinations of movements and tempos and the examples used in this description but are not intended to limit the scope of the invention.

### EXAMPLE 2

FIG. 8B illustrates a sensed signal 614 for an exercise activity having an approximate tempo of “1, 0, 1, 1”. In this example, the motion sensing unit 12 is located on a weight stack for a lateral pull down. A difference with this arrangement, compared with the arrangement of Example 1, is that the sensed signals for the other two axis of the accelerometer will be substantially steady and reasonably small in magnitude. In this example, unlike Example 1, the motion sensing unit begins its motion at the bottom (going up) with convention Ec, Ep, Con, Cp, with Ec being the upward movement.

As shown in the inset figure, as the trainee grabs the bar and sits down, the weight stack travels up as shown by section. This is the “top” position of the trainee's arms and the “bottom” position of the weight stack (WS) for the exercise activity. Positive acceleration 616 is evident as the trainee sits down in “set” position. Negative acceleration 618 indicates the trainee has reached the seat so the weight stack momentarily stops travelling up in the “set” position (WS=down). Positive acceleration 620 indicates the start of repetition 1 (pulling down on the bar results in the weight stack going up).

Negative acceleration 622 then indicates that the trainee has reached the bottom of the pulling down motion, and thus that the weight stack stops travelling up (WS=up), whilst further negative acceleration 624 indicates that the trainee has let their arms travel up and the weight stack starts downward.

Small positive acceleration 626 indicates that the trainee has controlled the weight stack, has stopped it, and then steadied for a 1 second with the bar up position (WS=down). Further positive acceleration 626 then indicates that the trainee has started a second repetition, by pulling down on the bar, which results in the weight stack going up.

In view of the above, it will be appreciated that embodiments of the present invention may allow recording and storing of values of one or more exercise parameters, including values of timing and/or duration information for at least one of an eccentric, eccentric pause, concentric, or concentric pause phase of a muscle or muscle group stressed by the exercise activity for processing to determine the training effectiveness of an exercise activity.

Although in the above described embodiments the invention is implemented primarily using computer software, in other embodiments the invention may be implemented primarily in hardware using, for example, hardware components such as “an application specific integrated circuit (ASICs). Implementation of a hardware state machine so as to perform the functions described herein will be apparent to persons skilled in the relevant art. In other embodiments, the invention may be implemented using a combination of both hardware and software.

Further aspects of the method will be apparent from the above description of the system. Persons skilled in the art will also appreciate that the method can be embodied in program code. The program code could be supplied in a number of ways, for example on a tangible computer readable medium, such as a disc or a memory or as a data signal or data file. It will be understood to persons skilled in the art of the invention that many modifications may be made without departing from the spirit and scope of the invention; in particular, it will be apparent that certain features of the embodiments of the invention can be employed to form further embodiments.

Finally, it is to be understood that, if any prior art is referred to herein, such reference does not constitute an admission that the prior art forms a part of the common general knowledge in the art in any country.

1-25. (canceled)

26. An exercise monitoring system, including:
a motion sensing unit for sensing motion during an exercise activity including plural repetitions, and providing sensor data based on the sensed motion; and
a processing unit for processing the sensor data to:
determine a value for each of one or more exercise parameters associated with a muscle or muscle group stressed by the exercise activity for each repetition; detect each of the plural repetitions of the exercise activity; and associate each determined value of the one or more exercise parameters with a respective detected repetition;
wherein the determined values of the one or more exercise parameters include a value of timing and/or duration information for at least one of an eccentric, eccentric pause, concentric, or concentric pause phase of a muscle or muscle group stressed by the exercise activity.

27. An exercise monitoring system according to claim 26 wherein the motion sensing unit includes at least one accelerometer, and wherein the sensed data is indicative of acceleration and/or displacement during execution of the exercise activity.

28. An exercise monitoring system according to claim 27 wherein the motion sensing unit includes a first accelerometer for providing sensor data based on sensed motion directed along a first axis and a second accelerometer for providing sensor data based on sensed motion directed along a sensing motion directed along a second axis, and wherein the first accelerometer and the second accelerometers are arranged so that the first and second axes are orthogonal axes.

29. An exercise monitoring system according to claim 28 wherein the motion sensing unit further includes a third accelerometer for providing a third sensor data based on sensed motion directed along a third axis, wherein the third accelerometer is arranged so that the first, second and third axes are orthogonal axes.

30. An exercise monitoring system according to claim 27 wherein the processing unit processes the sensor data from each of the at least one accelerometers to determine the value of the at least one exercise parameters associated with a muscle or muscle group stressed by the exercise activity

31. An exercise monitoring system according to claim 26 wherein the processing unit and the motion sensing unit are separate units, and wherein the motion sensing unit includes a wireless transmitter for communicating the sensed data to a wireless receiver of the processing means via a wireless communications interface.

32. An exercise monitoring system according to claim 26 wherein the exercise activity is a resistance training exercise involving displacing a load, and wherein the sensed motion includes a motion of the load attributable to the stressing of the muscle or muscle group during the exercise activity.

33. An exercise monitoring system according to claim 26 further including an attachment means for attaching at least the motion sensing unit to an exercise apparatus or an exercise equipment item displaced during the exercise activity.

34. An exercise monitoring system according to claim 26 further including input means for entering one or more exercise attributes associated with the exercise activity.

35. An exercise monitoring system according to claim 34 wherein the one or more exercise attributes associated with the exercise activity includes a type or category of exercise activity.

36. An exercise monitoring system according to claim 35 further including an indicating means for indicating a required orientation and/or alignment of the motion sensing means based on the type or category of the exercise activity so that at least one sensing axis is aligned with a plane of motion of the exercise activity.

37. An exercise monitoring system according to claim 26 wherein the processing means assigns a value to each detected repetition, each assigned value indicating a position of the repetition in a sequence of the plurality of repetitions.

38. An exercise monitoring system according to claim 26 further including a computer readable memory storing prescribed attributes for the exercise activity, the prescribed attributes including at least a number of prescribed repetitions for the exercise activity.

39. An exercise monitoring system according to claim 26 wherein processing the sensor data by the processing unit further includes processing the sensor data to detect an initial repetition of the exercise activity.

40. An exercise monitoring system according to claim 38, wherein processing the sensor data by the processing unit further includes comparing the assigned repetition value with the number of prescribed repetitions of the at least one exercise activity to identify the end of the exercise activity.

41. An exercise monitoring system, including:
a motion sensing unit for sensing motion during an exercise activity including plural repetitions, and providing sensor data based on the sensed motion, the motion sensing unit including at least one accelerometer such that the sensor data is indicative of acceleration and/or displacement during execution of the exercise activity;
a computer readable memory storing prescribed attributes for the exercise activity, the prescribed attributes including at least the number of prescribed repetitions of the exercise activity;
a processing unit for processing the sensor data to:
determine a value for each of one or more exercise parameters associated with a muscle or muscle group stressed by the exercise activity, the determined values including a value of timing and/or duration information for at least one of an eccentric, eccentric pause, concentric, or concentric pause phase of a muscle or muscle group stressed by the exercise activity;
detect each of the plural repetitions of the exercise activity; and
associate each determined value of at the least one exercise parameters with a respective detected repetition; and
memory means for storing the association between each of the determined values of the one or more exercise parameters and a respective detected repetition.

42. A method for monitoring an exercise activity including plural repetitions, the method including:
providing a motion sensing unit to sense motion during the exercise activity and provide sensor data based on the sensed motion; and
processing the sensor data to:
determine a value for each of one or more exercise parameters associated with a muscle or muscle group stressed by the exercise activity;
detect each of the plural repetitions of the exercise activity; and associate each determined value of the one or more exercise parameters with a respective detected repetition;
wherein the determined values of the one or more exercise parameters includes a value of timing and/or duration information for at least one of an eccentric, eccentric pause, concentric, or concentric pause phase of a muscle or muscle group stressed by the exercise activity.

43. A method of monitoring an exercise activity including plural repetitions, the method including:
providing a motion sensing unit for sensing motion during an exercise activity including plural repetitions, and providing sensor data based on the sensed motion, the motion sensing unit includes at least one accelerometer such that the sensor data is indicative of acceleration and/or displacement during execution of the exercise activity;
providing a computer readable memory storing prescribed attributes for the exercise activity, the prescribed attributes including at least a number of prescribed repetitions of the exercise activity for execution as a set; and
processing the sensor data to:
determine a value for each of one or more exercise parameters associated with a muscle or muscle group stressed by the exercise activity, the determined values including a value of timing and/or duration information for at least one of an eccentric, eccentric pause, concentric, or concentric pause phase of a muscle or muscle group stressed by the exercise activity;
detect each of the plural repetitions of the exercise activity;
associate each determined value of the one or more exercise parameters with a respective detected repetition;
compare the detected number of repetitions with the prescribed number of repetitions; and
identify the end of the set according to the comparison.

44. A processing unit for processing sensor data from a motion sensing unit, said sensor data including data indicative of acceleration of the motion sensing unit with respect to one or more axes during execution of plural repetitions of an exercise activity, the processing unit including:
means for determining a value for each of one or more exercise parameters associated with a muscle or muscle group stressed by the exercise activity for each repetition of the exercise activity;
means for detecting each of the plural repetitions of the exercise activity; and
means for associating each determined value of the one or more exercise parameters with a respective detected repetition;
wherein the values of the one or more exercise parameters include a value of timing and/or duration information for at least one of an eccentric, eccentric pause, concentric, or concentric pause phase of a muscle or muscle group stressed by the exercise activity.

45. A computer readable media including computer readable instructions which are executable by a computer to:
input sensor data indicative of acceleration of a motion sensing unit with respect to one or more axes during an exercise activity;
determine values of one or more exercise parameters associated with a muscle or muscle group stressed by the exercise activity, the determined values including a value of timing and/or duration information for at least one of an eccentric, eccentric pause, concentric, or concentric pause phase of a muscle or muscle group stressed by the exercise activity;
detect each of plural repetitions of the exercise activity;
associate each determined value of at the least one exercise parameters with a respective detected repetition; and
store associations between each of the determined values of the one or more exercise parameters and a respective detected repetition.
